(19) United States
(12) Patent Application Publication
(10) Pub. No.: US 2026/0059457 A1
(43) Pub. Date: Feb. 26, 2026

(54) SYNCHRONIZATION SIGNAL BLOCK (SSB) PATTERN SWITCHING

(71) Applicant: QUALCOMM Incorporated, San Diego, CA (US)

(72) Inventors: Kiran VENUGOPAL, Green Brook, NJ (US); Yan ZHOU, San Diego, CA (US); Raghu Narayan CHALLA, San Diego, CA (US); Yongle WU, San Diego, CA (US); Tao LUO, San Diego, CA (US); Yong LI, San Diego, CA (US); Navid ABEDINI, Basking Ridge, NJ (US); Jelena DAMNJANOVIC, Del Mar, CA (US)

(21) Appl. No.: 18/810,341

(22) Filed: Aug. 20, 2024

(51) Int. Cl. H04W 56/00; H04W 48/16

(52) U.S. Cl. CPC H04W 56/00; H04W 48/16

(57) ABSTRACT

Methods, systems, and devices for wireless communications are described. A network entity may transmit, based on a connection status of one or more wireless devices and in accordance with a first transmission pattern, a first plurality of primary synchronization signal (PSS) bursts and a first plurality of synchronization signal blocks (SSB) remainder bursts, the first transmission pattern indicating a first PSS burst length, a first PSS burst periodicity, and a first SSB remainder burst periodicity indicating at least a subset of the first plurality of PSS bursts that are associated with the first plurality of SSB remainder bursts. The network entity may transmit, based on a first change of the connection status and in accordance with a second transmission pattern, a second plurality of SSB remainder bursts, the second transmission pattern indicating a second SSB remainder burst periodicity smaller than the first SSB remainder burst periodicity.

### FIELD OF TECHNOLOGY

The following relates to wireless communications, including synchronization signal block (SSB) pattern switching.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a wireless device may communicate a synchronization signal block (SSB). However, such approaches may be improved.

### SUMMARY

The systems, methods, and devices of this disclosure each have several innovative aspects, no single one of which is solely responsible for the desirable attributes disclosed herein.

A method for wireless communications by a network entity is described. The method may include transmitting, based on a connection status of one or more wireless devices that are associated with the network entity and in accordance with a first transmission pattern, a first set of multiple primary synchronization signal (PSS) bursts and a first set of multiple synchronization signal blocks (SSB) remainder bursts, the first transmission pattern indicating a first PSS burst length, a first PSS burst periodicity, and a first SSB remainder burst periodicity indicating at least a subset of the first set of multiple PSS bursts that are associated with the first set of multiple SSB remainder bursts and transmitting, based on a first change of the connection status and in accordance with a second transmission pattern, a second set of multiple SSB remainder bursts, the second transmission pattern indicating a second SSB remainder burst periodicity is smaller than the first SSB remainder burst periodicity.

A network entity for wireless communications is described. The network entity may include one or more memories storing processor executable code, and one or more processors coupled with the one or more memories. The one or more processors may individually or collectively be operable to execute the code to cause the network entity to transmit, based on a connection status of one or more wireless devices that are associated with the network entity and in accordance with a first transmission pattern, a first set of multiple PSS bursts and a first set of multiple synchronization signal blocks (SSB) remainder bursts, the first transmission pattern indicating a first PSS burst length, a first PSS burst periodicity, and a first SSB remainder burst periodicity indicating at least a subset of the first set of multiple PSS bursts that are associated with the first set of multiple SSB remainder bursts and transmit, based on a first change of the connection status and in accordance with a second transmission pattern, a second set of multiple SSB remainder bursts, the second transmission pattern indicating a second SSB remainder burst periodicity is smaller than the first SSB remainder burst periodicity.

Another network entity for wireless communications is described. The network entity may include means for transmitting, based on a connection status of one or more wireless devices that are associated with the network entity and in accordance with a first transmission pattern, a first set of multiple PSS bursts and a first set of multiple synchronization signal blocks (SSB) remainder bursts, the first transmission pattern indicating a first PSS burst length, a first PSS burst periodicity, and a first SSB remainder burst periodicity indicating at least a subset of the first set of multiple PSS bursts that are associated with the first set of multiple SSB remainder bursts and means for transmitting, based on a first change of the connection status and in accordance with a second transmission pattern, a second set of multiple SSB remainder bursts, the second transmission pattern indicating a second SSB remainder burst periodicity is smaller than the first SSB remainder burst periodicity.

A non-transitory computer-readable medium storing code for wireless communications is described. The code may include instructions executable by one or more processors to transmit, based on a connection status of one or more wireless devices that are associated with the network entity and in accordance with a first transmission pattern, a first set of multiple PSS bursts and a first set of multiple synchronization signal blocks (SSB) remainder bursts, the first transmission pattern indicating a first PSS burst length, a first PSS burst periodicity, and a first SSB remainder burst periodicity indicating at least a subset of the first set of multiple PSS bursts that are associated with the first set of multiple SSB remainder bursts and transmit, based on a first change of the connection status and in accordance with a second transmission pattern, a second set of multiple SSB remainder bursts, the second transmission pattern indicating a second SSB remainder burst periodicity is smaller than the first SSB remainder burst periodicity.

Some examples of the method, network entities, and non-transitory computer-readable medium described herein may further include operations, features, means, or instructions for transmitting, based on a second change in the connection status and in accordance with a third transmission pattern, a second set of multiple PSS bursts and a third set of multiple SSB remainder bursts, the third transmission pattern indicating a second PSS burst length, a second PSS burst periodicity, and a third SSB remainder burst periodicity indicating at least a subset of the second set of multiple PSS bursts that may be associated with the third set of multiple SSB remainder bursts.

In some examples of the method, network entities, and non-transitory computer-readable medium described herein, the third SSB remainder burst periodicity may be less than the first SSB remainder burst periodicity and may be greater than the second SSB remainder burst periodicity.

In some examples of the method, network entities, and non-transitory computer-readable medium described herein, the third SSB remainder burst periodicity may be equal to the second PSS burst periodicity.

In some examples of the method, network entities, and non-transitory computer-readable medium described herein, each respective PSS burst of the second set of multiple PSS bursts includes a set of PSS transmissions associated with discontinuous SSB identifiers that may be associated with a respective SSB remainder burst of the third set of multiple SSB remainder bursts.

In some examples of the method, network entities, and non-transitory computer-readable medium described herein, each PSS burst indicates of the first set of multiple PSS bursts indicates a respective offset value that indicates a later-occurring PSS burst of the first set of multiple PSS bursts that may be associated with a next-occurring SSB of the first set of multiple SSB remainder bursts.

In some examples of the method, network entities, and non-transitory computer-readable medium described herein, the respective offset value indicates a first value for a first cell and a second value for a second cell and the first SSB remainder burst periodicity indicates a first periodicity associated with the first cell and a second periodicity associated with the second cell.

In some examples of the method, network entities, and non-transitory computer-readable medium described herein, each PSS burst of the first set of multiple PSS bursts may be associated with one or more first beams over which the PSS burst may be transmitted and each SSB remainder burst of the first set of multiple SSB remainder bursts may be associated with one or more second beams over which the SSB remainder burst may be transmitted, where the one or more second beams may be narrower than the one or more first beams, and where a quantity of the one or more second beams may be greater than a quantity of the one or more first beams.

In some examples of the method, network entities, and non-transitory computer-readable medium described herein, transmission of each SSB of each SSB remainder burst of the second set of multiple SSB remainder bursts includes outputting of a tracking reference signal, a channel state information reference signal, or both.

Some examples of the method, network entities, and non-transitory computer-readable medium described herein may further include operations, features, means, or instructions for transmitting an indication of the first transmission pattern, the second transmission pattern, or both, where the indication may be associated with operation of a secondary cell.

In some examples of the method, network entities, and non-transitory computer-readable medium described herein, the indication of the first transmission pattern, the second transmission pattern, or both, includes an indication of one or more pattern indices.

In some examples of the method, network entities, and non-transitory computer-readable medium described herein, the first change of the connection status includes a change from an idle status to a connected status.

In some examples of the method, network entities, and non-transitory computer-readable medium described herein, at least a portion of the first set of multiple SSB remainder bursts, the second set of multiple SSB remainder bursts, or both includes SSB remainder bursts that include fewer symbols than a remaining portion of the first set of multiple SSB remainder bursts, the second set of multiple SSB remainder bursts, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communications system that supports SSB pattern switching in accordance with one or more examples as disclosed herein.

FIG. 2 shows examples of SSB transmission schemes that support SSB pattern switching in accordance with one or more examples as disclosed herein.

FIG. 3 shows an example of a SSB transmission scheme that supports SSB pattern switching in accordance with one or more examples as disclosed herein.

FIG. 4 shows an example of a SSB transmission scheme that supports SSB pattern switching in accordance with one or more examples as disclosed herein.

FIG. 5 shows an example of a SSB transmission scheme that supports SSB pattern switching in accordance with one or more examples as disclosed herein.

FIG. 6 shows an example of a SSB transmission scheme that supports SSB pattern switching in accordance with one or more examples as disclosed herein.

FIG. 7 shows an example of a SSB transmission scheme that supports SSB pattern switching in accordance with one or more examples as disclosed herein.

FIG. 8 shows an example of a SSB transmission scheme that supports SSB pattern switching in accordance with one or more examples as disclosed herein.

FIG. 9 shows an example of a SSB transmission scheme that supports SSB pattern switching in accordance with one or more examples as disclosed herein.

FIG. 10 shows an example of a process flow that supports SSB pattern switching in accordance with one or more examples as disclosed herein.

FIGS. 11 and 12 show block diagrams of devices that support SSB pattern switching in accordance with one or more examples as disclosed herein.

FIG. 13 shows a block diagram of a communications manager that supports SSB pattern switching in accordance with one or more examples as disclosed herein.

FIG. 14 shows a diagram of a system including a device that supports SSB pattern switching in accordance with one or more examples as disclosed herein.

FIG. 15 shows a flowchart illustrating methods that support SSB pattern switching in accordance with one or more examples as disclosed herein.

### DETAILED DESCRIPTION

In wireless communications, synchronization signal blocks (SSBs) may be used to aid wireless devices and connecting to network entities. However, frequent transmission of SSBs may result in undesirable amounts of energy consumption at network entities. In some examples, it may be desirable to transmit SSBs less frequently while still maintaining functionality to allow wireless devices to connect to network entities. For example, some approaches may include transmitting a periodic primary synchronization signal (PSS) without transmitting an SSB. However, the energy saving benefits from such approaches are not available to networks that are loaded more heavily. Thus, it may be desirable to explore techniques that allow for switching between different transmission patterns of SSBs.

In some examples, a network entity may transmit the transmission pattern associated with an idle state of one or more associated wireless devices, such as user equipments (UEs). For example, such a pattern may include a regularly transmitted PSS burst and an SSB burst that may be transmitted with a greater periodicity than that of the PSS burst. In response to detecting that the UE has changed its connection state (e.g., from an idle state to a connected state) the network entity may transition to using a different transmission pattern (e.g., that includes a regularly transmitted SSB burst that is of a reduced periodicity as compared to the previous periodicity of the SSB in the first transmission pattern). In some examples, intermediate transmission patterns may be used that may include additional SSB burst occasions transmitted at a greater frequency than the idle pattern and at a lesser frequency than in the connected pattern. In at least these ways, network energy savings may be increased while still offering availability for devices to search for and connect to the network entity, thereby maintaining or improving communications quality, flexibility, reliability, latency, and overhead.

Aspects of the disclosure are initially described in the context of wireless communications systems. Aspects of the disclosure are then described with reference to a wireless communications system and SSB transmission schemes. Aspects of the disclosure are further illustrated by and described with reference to apparatus diagrams, system diagrams, and flowcharts that relate to SSB pattern switching.

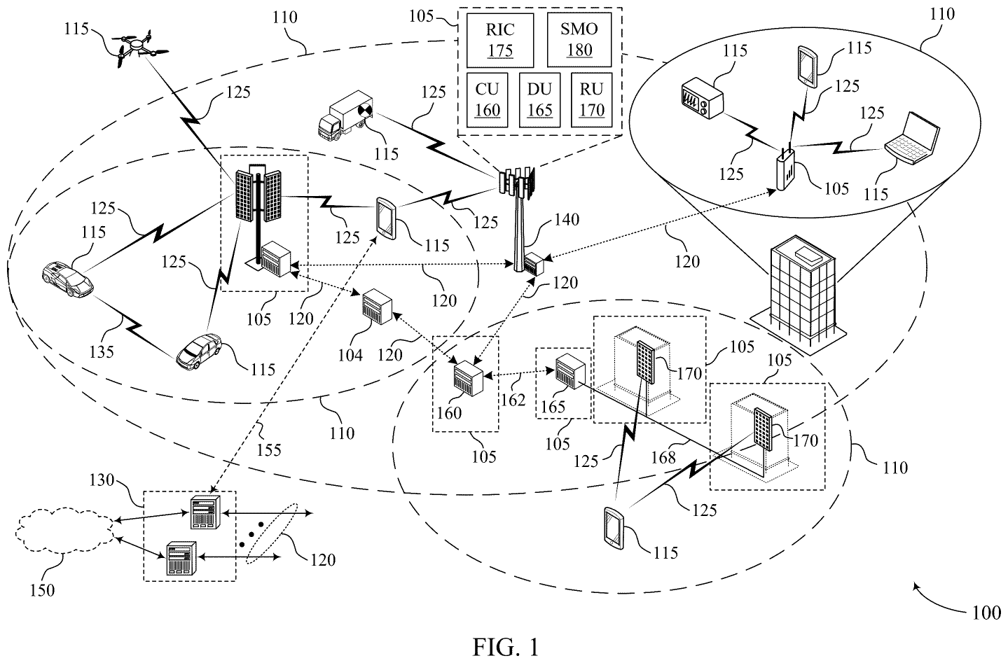

FIG. 1 shows an example of a wireless communications system 100 that supports SSB pattern switching in accordance with one or more examples as disclosed herein. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a network entity may transmit different transmission patterns of SSBs if one or more conditions, such as connection states of an associated wireless device (e.g., a UE), are satisfied. For example, a first connection state may be an idle state and an associated first transmission pattern may transmit SSB bursts at a longer periodicity (e.g., an amount of time between transmitting the SSB bursts may be longer) than a second transmission pattern associated with an active state of a wireless device (e.g., which may include more frequency transmission of SSB bursts than the first transmission pattern). Further, the network entity may transition between different transmission patterns based on transitions between different connection states (e.g., idle to active/connected, vice-versa, or one or more other connection state transitions).

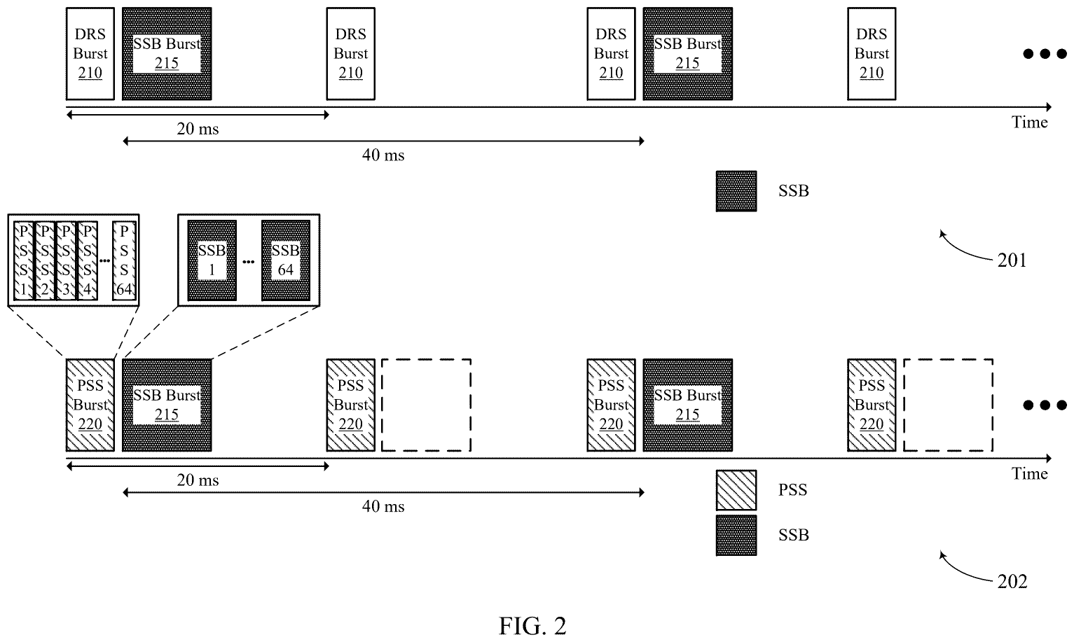

FIG. 2 shows an example of an SSB transmission scheme 201 and another SSB transmission scheme 202 that support SSB pattern switching in accordance with one or more examples as disclosed herein.

In wireless communications SSBs are used in connection with initial cell search procedures. An SSB may span 4 OFDM symbols, which may include 1 symbol for a PSS, 2 symbols for physical broadcast channel (PBCH) transmissions, and 1 symbol in which a secondary synchronization signal (SSS) and PBCH transmissions are multiplexed via frequency division multiplexing (FDM).

In some examples, a PSS may employ a frequency domain-based M-sequence of length 127 (e.g., mapped to 127 subcarriers (SCs)), and may include multiple possible sequences (e.g., three sequences). In some examples, an SSS may include a frequency domain-based Gold Code sequence (e.g., 2 M-sequences) of length 127 (e.g., mapped to 127 SCs), which may include 1008 possible sequences. In some examples, the PBCH portions of the SSB may be modulated via quadrature phase shift keying (QPSK) and may be coherently demodulated using an associated demodulation reference signal (DMRS).

In some examples, energy consumption may be a concern for wireless communications network infrastructure, as frequent SSB transmissions may result in increased energy consumption. Conversely, less frequent SSB transmission may result in lower energy consumption but may also lead to higher initial access latency, causing performance loss and inability to support low latency type applications. Thus, a balanced design may be desirable.

For example, such as in the SSB scheme 201 for a mmWave frequency band (e.g., a frequency range 2 (FR2) frequency band), a dual-burst sync signal may be used (e.g., to reduce SSB energy and overhead while maintaining a cell presence detection latency). Such a sequence may include a discovery reference signal (DRS) burst, such as a DRS burst 210 and an SSB burst 215, and such a sequence may include different combinations of DRS bursts 210 and SSB bursts 215. The DRS burst 210 may be or include a 1-symbol common PSS or a limited search hypothesis signal. The SSB burst 215 may be a three or four (or other quantity) SSB. For example, for a three symbol SSB, the SSB burst 215 may include a 1-symbol cell-specific SSS and a 2-symbol PBCH portion. In some examples, the SSB burst 215 and other SSB bursts described herein may be described as SSB remainder bursts, as, in some examples, such SSB remainder bursts may not include a PSS, as the PSS may be transmitted separately as described herein. Additionally, or alternatively, the SSB remainder burst may not include transmission of all elements of an SSB and may instead include a subset of elements of an SSB (e.g., which may be accompanied by or associated with transmission of a PSS burst). Reference herein to an SSB burst may be interpreted to include at least a “full” SSB burst as well as an SSB remainder burst (that includes a subset of SSB elements in one or more transmissions). Further, description of an SSB remainder burst herein includes transmission of one or more SSBs with all of the SSB elements., transmission of one or more SSBs that include a subset of SSB elements (e.g., which may be accompanied by or associated with transmission of a PSS burst), or both.

In some examples, such as the SSB scheme 202, a PSS sequence may be transmitted as a compact burst (e.g., the PSS burst 220), which may be transmitted without any symbol gap between the sequences (e.g., at a first period, e.g., 20 ms) while the SSB bursts 215 (e.g., a 3-symbol (truncated) SSB) may be transmitted less often. In such examples, an unmodified PSS sequence may be used. Though the remaining SSB portion (e.g., the SSB burst 215) may be transmitted later, a UE may use information from PSS detection (e.g., of the PSS burst 220) to decode a corresponding SSS and PBCH (e.g., of the SSB burst 215). In some examples, as the SSS and the rest of the SSB may be transmitted separately, the PSS burst 220 may be less reliable to provide timing for SSS decoding (e.g., even though there may be a higher amount of energy savings in such a scheme) and it may be desirable to modify UE implementation.

Additionally, or alternatively, fewer RMSI symbols for the SSB burst 215 may be available for multiplexing patterns 2 and 3.

Additionally, or alternatively, in the SSB scheme 202, in an option, PSS sequences may be transmitted as compact bursts (e.g., the PSS bursts 220) without any symbol gap between the sequences (e.g., at a period of 20 ms), while the SSB bursts 215 (e.g., a 4-symbol (e.g., legacy) SSB burst 215) may be transmitted less often. In such cases, an enhanced PSS sequence (e.g., to be included in the PSS bursts 220) may be used. In some examples, such an enhancement or modification may include a reduced transmission power at a transmitting device, a lower detection complexity at a receiving device, reduced power consumption at a receiving device, or any combination thereof. In some examples, as the SSS and the rest of the SSB may be transmitted separately, the PSS (e.g., of the PSS bursts 220) may not be able to provide timing for SSS decoding. As such, in some examples, a four symbol (e.g., legacy) SSB may still be transmitted (e.g., included in the SSB bursts 215) at a long period (e.g., 40, 60, or 80 ms). In some examples, such techniques could lead to higher amounts of blind detection at received device (e.g., a UE) as different sets of PSS may be involved.

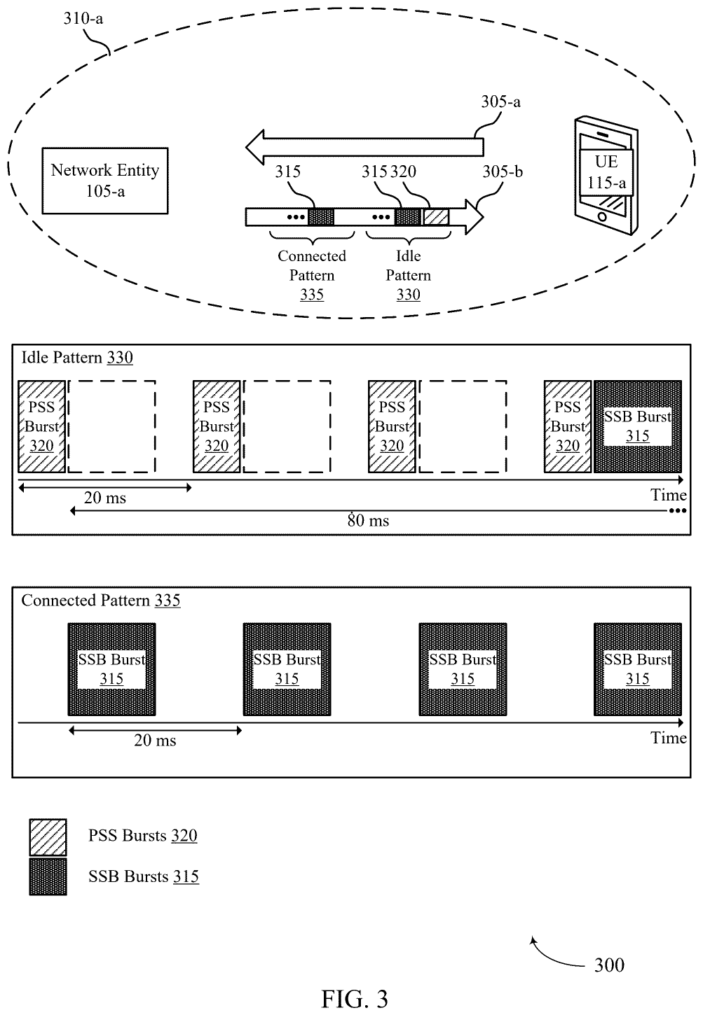

In some examples, in a network or cell with a relatively small quantity of connected UEs, a compact PSS burst may be used and transmitted at a period (e.g., every 20 ms) and a corresponding three or four symbol SSB transmitted at a longer period (40 ms, 60 ms or 80 ms). However, energy saving benefits resulting from this pattern may be less significant in larger networks (e.g., with a relatively large quantity of connected UEs). For example, in the presence of a connected UE, the 4-symbol (legacy) SSB burst 215 may be transmitted more frequently (e.g., at a period of 20 ms). In such a case, transmitting the SSB bursts 215 at both an idle pattern and a “connected pattern” may lead to additional overhead. For example, an idle pattern may be a pattern in which a plurality of PSS bursts are transmitted at a first periodicity and SSB bursts are transmitted at a longer periodicity (e.g., SSB bursts are transmitted less frequently than PSS bursts). One example of such an idle pattern may be the idle pattern 330 described in more detail with reference to FIG. 3. Further, a connected pattern may be a pattern in which SSB bursts are transmitted without any PSS bursts. One example of such a connected pattern may be the connected pattern 335 described in more detail with reference to FIG. 3. As such, SSB pattern switching may be desirable to avoid SSB overhead increases.

FIG. 3 shows an example of a SSB transmission scheme 300 that supports SSB pattern switching in accordance with one or more examples as disclosed herein.

The SSB transmission scheme 300 may involve the network entity 105-a, which may be an example of one or more network entities discussed in relation to other figures. The SSB transmission scheme 300 may involve the UE 115-a, which may be an example of UEs discussed in relation to other figures. In some examples, the network entity 105-a and the UE 115-a may operate within a coverage area 310-a. In some examples, the network entity 105-a and the UE 115-a may communicate via one or more uplinks 305-a and one or more downlinks 305-b.

In some examples, the network entity 105-a may transmit different patterns of PSS bursts 320, SSB bursts 315, or any combination thereof, at different times, and may do so based on one or more conditions, such as a connection status of one or more wireless devices. The discussion here involves the UE 115-a as an example of such wireless devices that may have or be associated with a connection status that may form a basis for switching between different patterns, including the idle pattern 330 and the connected pattern 335. However, the techniques described herein may be applied to any quantity of any wireless devices. Further, though the examples provide some values for periods or other parameters, the techniques described herein may be applied to any values of any parameters described.

In some examples, if the network entity 105-a does not measure or detect that the UE 115-a is in a connected mode or state, the network entity 105-a may transmit the PSS bursts 320 and the SSB bursts 315 in accordance with the idle pattern 330. The idle pattern 330 may include, for example, a compact 1 symbol PSS burst 320 at a period of 20 ms and a four symbol SSB burst 315 with a longer period (e.g., 80 ms). In some examples, PSSs used in the PSS burst 320 may be the same PSS as a PSS transmitted in the SSB bursts 315 or may be different PSSs.

However, in some examples, if the network entity 105-a does measure or detect that the UE 115-a is in a connected mode or state, the network entity 105-a may transmit the PSS bursts 320, the SSB bursts 315, or both in accordance with the connected pattern 335. The connected pattern 335 may include one or more periods or other parameters (e.g., for the PSS bursts 320, the SSB bursts 315, or both) that may differ from those of the idle pattern 330. For example, in the connected pattern 335, no PSS bursts 320 may be transmitted, and the SSB bursts 315 may be transmitted at a period of 20 ms.

In some examples, the use of a compact PSS burst (e.g., as depicted in the idle pattern 330) may promote network energy savings by removing an inter-PSS gap. Further, using the same PSS sequence (e.g., across the PSS bursts 320 and the SSB bursts 315) may simplify processing at the UE 115-a for blind peak detection).

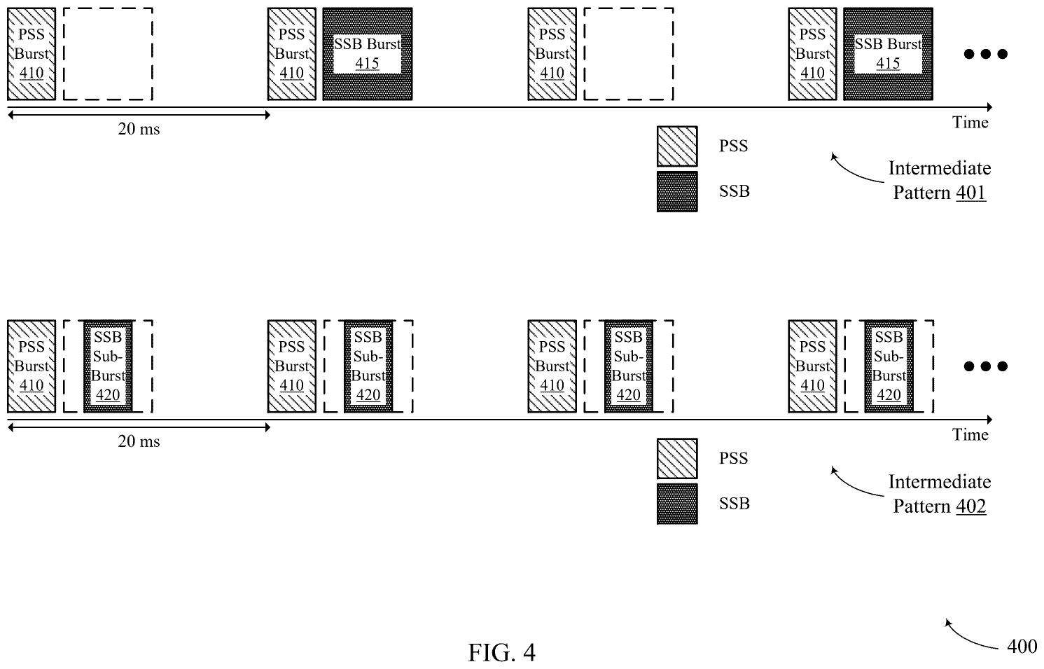

FIG. 4 shows an example of a SSB transmission scheme 400 that supports SSB pattern switching in accordance with one or more examples as disclosed herein. In the SSB transmission scheme 400, a network entity may transmit one or more intermediate patterns, including the intermediate pattern 401 and the intermediate pattern 402.

For example, in addition to or instead of switching between idle and connected patterns (e.g., the idle pattern 330 and the connected pattern 335), a network entity may transmit intermediate pattern. Such intermediate patterns may add one or more additional SSB bursts 415 (e.g., as compared to an idle pattern) for connected wireless devices while reducing the overall overhead compared with the connected pattern 335. For example, the intermediate pattern 401 may include or be associated with a shorter period of the SSB bursts 415 (e.g., as compared to the idle pattern 330), such as a 40 ms period, and may include the transmission of the PSS bursts 410 (e.g., at a 20 ms period). Further, the intermediate pattern 402 may include or be associated with a 20 ms period for transmitting the SSB sub-bursts 420 (e.g., along with the transmission of the PSS bursts 410 at a 20 ms period). The SSB sub-bursts 420 may include a subset of elements of the SSB bursts 415 (e.g., a four symbol SSB burst).

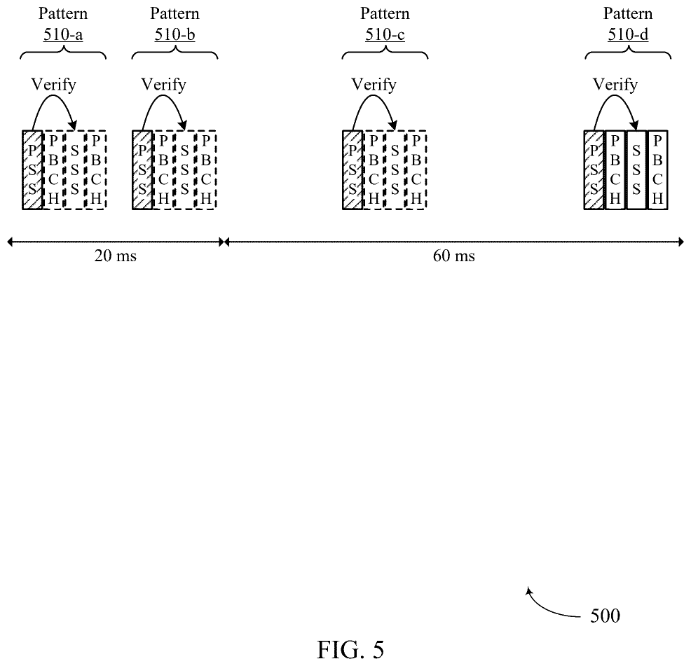

FIG. 5 shows an example of a SSB transmission scheme 500 that supports SSB pattern switching in accordance with one or more examples as disclosed herein.

In some examples, a UE may monitor for one or more PSSs (e.g., included in the PSS bursts, SSB bursts, or both, as described herein). If the UE detects a PSS in the first 20 ms, the UE may attempt to verify whether a SSS follows soon after the PSS (e.g., within a period of transmission of the PSS or PSS bursts or within a threshold amount of time of transmitting a PSS burst). If the UE detects a PSS but does not detect an associated SSS detected, the UE may continue monitoring for further PSSs in the following 60 ms and again attempt to verify the presence of an SSS with one or more additional PSSs. The UE may repeat monitoring for a PSS and monitoring for an accompanying SSS for a quantity of attempts. If, in response to attempting to locate a PSS with an accompanying SSS a threshold quantity of attempts without successfully detecting an SSS, the UE may switch to a different frequency to monitor for a PSS, an SSS, or both. In some examples, the conditional 60 ms scan assumes that an idle pattern is transmitted, (e.g., and not a connected pattern). Such a connected pattern could be verified (e.g., through monitoring for an associated SSS) in the first 20 ms after detecting the PSS.

For example, the UE may monitor the pattern 510-a, detect the PSS, and attempt to verify that an SSS follows. However, in the pattern 510-a, there is no SSS. As such, the UE may move on to monitor for another PSS, such as the one in the pattern 510-b, with the same results as those of the pattern 510-a (e.g., no detection of an SSS accompanying the PSS). The UE may continue to monitor for another PSS and accompanying SSS (e.g., at the pattern 510-c) with the same results. However, the UE may monitor for the PSS of pattern 510-d and monitor to verify that the SSS is present, which, in pattern 510-d, is true. The UE may then attempt to verify the presence of the SSS in pattern 510-d, which may be successful, as the pattern 510-d does include an SSS.

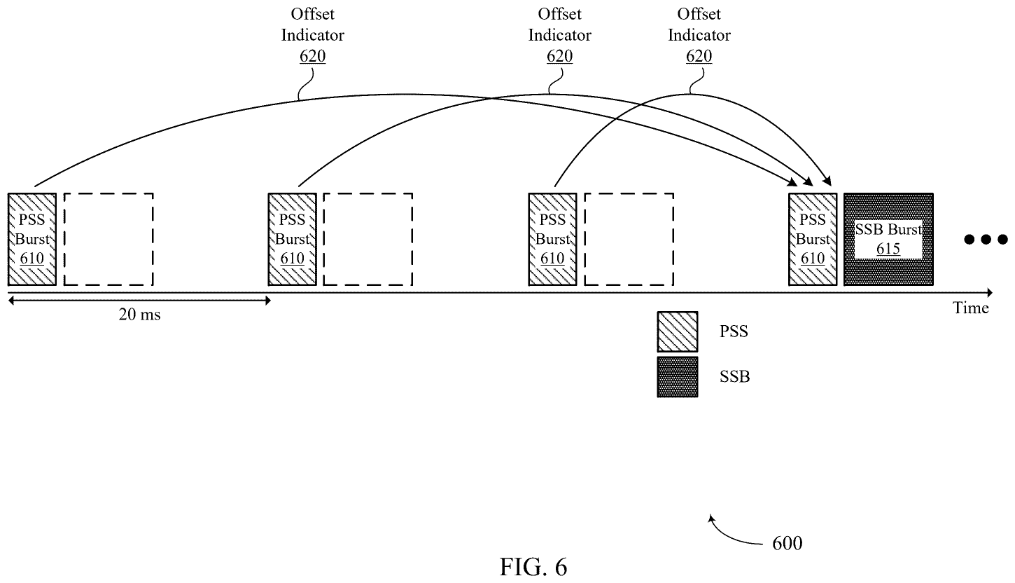

FIG. 6 shows an example of a SSB transmission scheme 600 that supports SSB pattern switching in accordance with one or more examples as disclosed herein.

In some examples, an offset indicator 620 may be used in association with each PSS burst 610 (e.g., the offset indicators 620 may be indicated in respective PSS bursts 610), which may include the use of an idle pattern (e.g., the idle pattern 330). The offset indicators 620 may indicate an offset from the PSS burst 610 in which the offset indicator 620 appears to the SSB burst 615 (e.g., which may be a next-occurring SSB burst or may be an SSB burst with an SSB identifier that is indicated in the offset indicator 620). In some examples, the SSB burst 615 may include four symbols SSBs, three symbol SSBs, or other types of SSBs (e.g., that include a subset of elements of a four symbols SSB). In some examples, the SSB burst 615 to which the offset indicators point or refer may be an SSB burst 615 that is within a detection window. For example, the offset indicators 620 may be individually associated with different offsets (e.g., given the different positions in time of the PSS bursts 610). Such offsets may be 0 ms, 20 ms, 40 ms, 60 ms, or another offset value within the detection window.

For example, suppose that a reserved SSB offset or no SSB offset is indicated (e.g., in the offset indicators 620) for each PSS burst 610 in an idle pattern, a connected pattern, one or more intermediate patterns, or any combination thereof. In this example, a UE may not scan for additional PSS bursts 610 in response to receiving a first PSS burst 610 with an offset indicator 620. Instead, the UE may directly search for the SSB burst 615 indicated in the offset indicator 620 during the detection window or in a quantity of starting locations after the indicated offset or the PSS burst 610.

Further, if the UE receives a PSS burst 610 including an offset indicator 620 that indicates a reserved SSB offset or no offset is detected soon after the PSS burst 610 (e.g., within 20 ms) the UE may proceed to monitor for an SSS whose presence is to be verified.

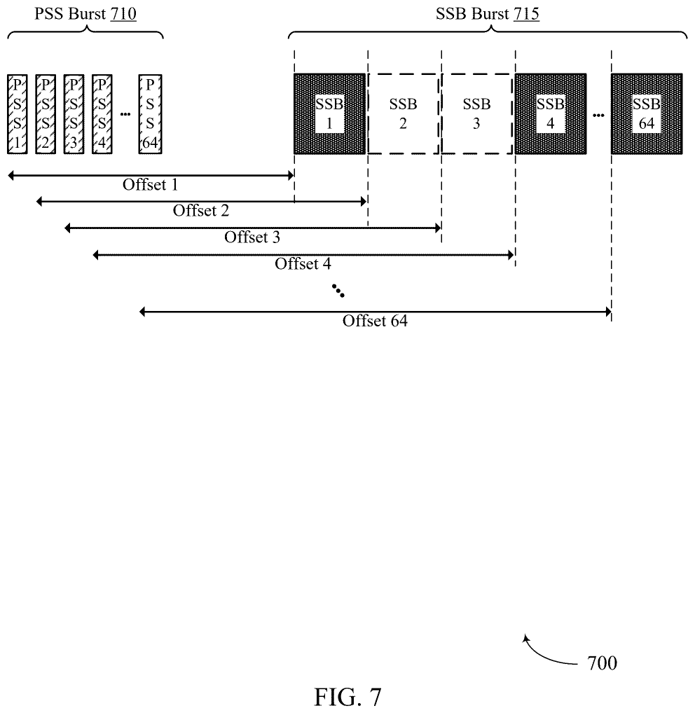

FIG. 7 shows an example of a SSB transmission scheme 700 that supports SSB pattern switching in accordance with one or more examples as disclosed herein.

In some examples employing the use of an intermediate pattern (e.g., between an idle pattern and a connected pattern), the network entity may activate a subset of discontinuous SSB IDs (e.g., of the set of SSB 1, SSB 2, SSB 3, SSB 4, and so on through SSB 64, where at least SSB 2 and SSB 3 are not included in the subset) of the SSB burst 715 where a complete set of PSSs (e.g., the PSS 1, PSS 2, PSS 3, PSS 4, and so on through PSS 64) are still transmitted in the PSS burst 710. In such a case, offsets (e.g., offset 1, offset 2, offset 3, offset 4, and so on through offset 64) between a PSS and an SSB may not be uniform (e.g., may not be the same amount of time as other offsets) given possible “gaps” in the identifiers of the SSBs due to employing a subset of the SSBs and not the complete set of SSBs. As such, the UE may not derive and instead monitor for the 64 possible SSB staring locations for a given detected PSS. Instead, UE may be aware that a detected PSS peak may be at any location in the PSS burst 710, based on which the UE may derive the corresponding SSB detection window. Thus, techniques for a continuous SSB scan in the SSB detection window may still be viable.

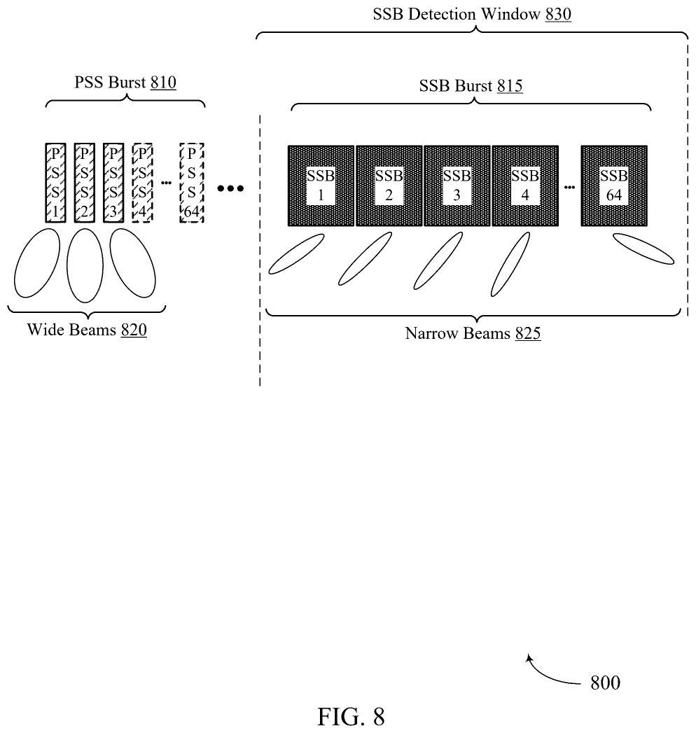

FIG. 8 shows an example of a SSB transmission scheme 800 that supports SSB pattern switching in accordance with one or more examples as disclosed herein.

In some examples, a PSS burst 810 may include or be associated with the use of fewer beams than an SSB burst 815. For example, the PSS burst 810 may involve three PSSs and the three wide beams 820 and the SSB burst 815 may involve 64 SSBs with the narrow beams 825 (e.g., sixty four narrow beams 825).

However, in such a case, there may not exist a 1-to-1 mapping between the PSSs and the SSBs with known offset. As such, a UE may not be able to derive an offset but may instead check the 64 possible SSB staring locations for a given detected PSS peak.

In some examples, the UE may determine that the detected PSS peak is somewhere within the PSS burst 810 (e.g., with 64 potential PSSs) based on which the UE may derive the SSB detection window 830.

Additionally, or alternatively, the UE may employ artificial intelligence or machine learning approaches. For example, if the UE obtains a wide beam index for one or more detected peaks and a wide/narrow beam relation (e.g., between the wide beams 820 and the narrow beams 825), and a burst pattern is fixed, it may be possible for the UE to predict one or more SSB beams (e.g., one or more of the narrow beams 825) and monitor the corresponding SSB locations based on detected PSS peaks.

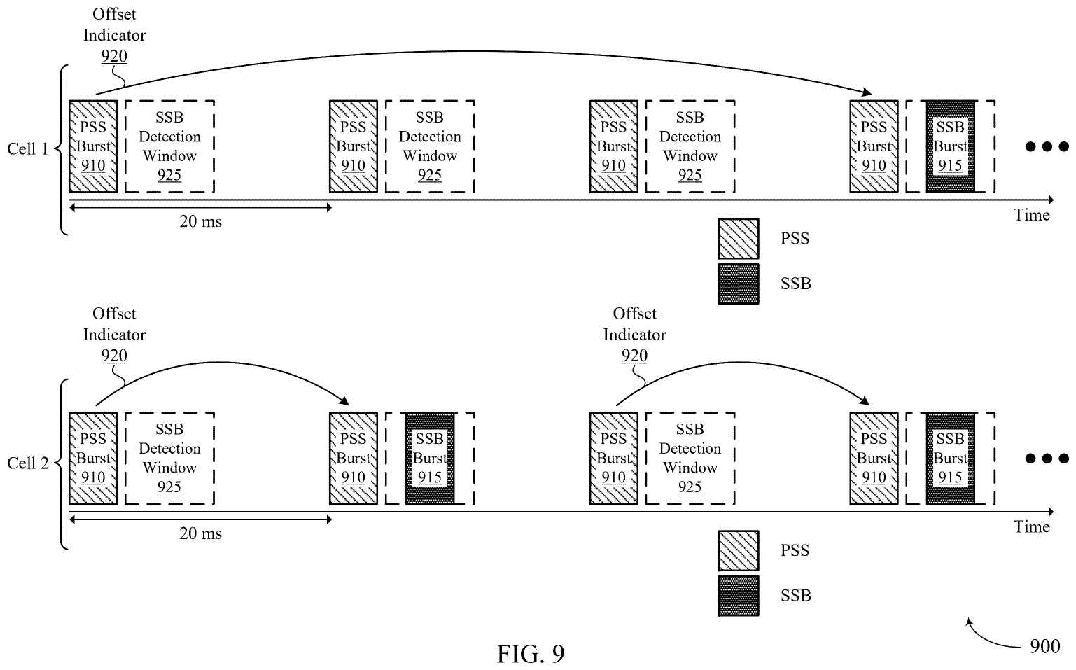

FIG. 9 shows an example of a SSB transmission scheme 900 that supports SSB pattern switching in accordance with one or more examples as disclosed herein.

In some examples, the SSB bursts 915 may be broadcast or transmitted at different periods for different cells. For example, the SSB bursts 915 for cell 1 may be transmitted at a different period or rate than the SSB bursts 915 for cell 2. In some examples in which no offset indicators are used, operation may be similar here, as a UE may search for an SSB (e.g., within an SSB detection window 925) in response to receiving a PSS burst 910, as the UE may not be aware of whether or where an SSB burst is to occur. However, for those examples that implement the offset indicator 920, indicator detection may be affected if different cells indicate different offsets on a same PSS symbol.

In some examples, for a connected UE, one or more PBCH functions (e.g., associated with one or more SSBs) may be replaced by a tracking reference signal (TRS), a channel state information reference signal (CSI-RS), or both, for beam management (e.g., tracking, beam measurement, cell measurement, receive beam refinement, one or more other operations, or any combination thereof). However, in some examples, the additional burst structure may increase idle UE SSB search complexity. In some examples, after PSS detection, SSS detection, or both, an idle UE may further determine whether the PBCH symbols include PBCH functions or a TRS, CSI-RS, or other reference signal, which may result in more hypotheses to consider.

In some examples, the network entity may transmit, to the UE, an indication of the SSB pattern that is to be used by the network entity. Further, the network entity may transmit such indications for one or more scenarios.

A first scenario may be a scenario in which a secondary cell (SCell) may be co-located with a primary cell (PCell) in a carrier aggregation scheme. In such a scenario, transmission of PSSs, SSSs, or both may not be employed in a four symbol SSB burst. Additionally, or alternatively, PBCH functions or operations may be replaced (e.g., with one or more reference signals, such as a TRS, a CSI-RS, one or more other reference signals, or any combination thereof).

A second scenario may be a scenario in which an SCell is not collocated with PCell. In such a scenario, transmission of PSSs, SSSs, or both may be employed, and PBCH elements may not be transmitted or may be replaced (e.g., with one or more reference signals, such as a TRS, a CSI-RS, one or more other reference signals, or any combination thereof).

A third scenario may be a scenario in which an SCell also serves as a PCell for another UE. In such a scenario, a similar pattern may be employed for the SCell operations as one that is applicable for the PCell operations.

In some examples, an SSB pattern may be referred to by either a pre-defined pattern index or by a detailed pattern description. Such a detailed pattern description may include indications of one or more references signals, channels, corresponding time/frequency locations within the SSB, the time/frequency locations of the SSBs, or any combination thereof.

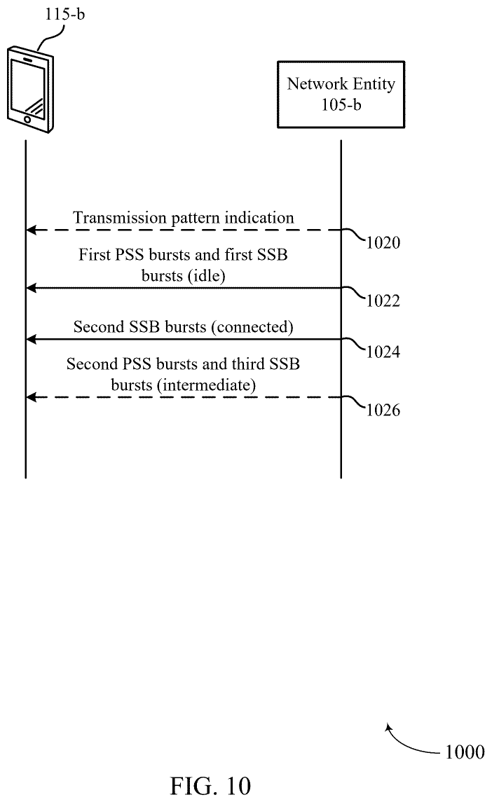

FIG. 10 depicts an example of a process flow that supports SSB pattern switching in accordance with one or more examples as disclosed herein. The process flow 1000 may implement various aspects of the present disclosure described herein. The elements described in the process flow 1000 (e.g., network entity 105-b and UE 115-b) may be examples of similarly named elements described herein.

In the following description of the process flow 1000, the operations between the various entities or elements may be performed in different orders or at different times. Some operations may also be left out of the process flow 1000, or other operations may be added. Although the various entities or elements are shown performing the operations of the process flow 1000, some aspects of some operations may also be performed by other entities or elements of the process flow 1000 or by entities or elements that are not depicted in the process flow, or any combination thereof.

At 1020, the network entity 105-b may transmit an indication of the first transmission pattern, the second transmission pattern, or both and the indication is associated with operation of a secondary cell. In some examples, the indication of the first transmission pattern, the second transmission pattern, or both, may include an indication of one or more pattern indices.

At 1022, the network entity 105-b may transmit, based on a connection status of one or more wireless devices that are associated with the network entity and in accordance with a first transmission pattern, a first plurality of primary synchronization signal (PSS) bursts and a first plurality of synchronization signal blocks (SSB) remainder bursts, the first transmission pattern indicating a first PSS burst length, a first PSS burst periodicity, and a first SSB remainder burst periodicity indicating at least a subset of the first plurality of PSS bursts that are associated with the first plurality of SSB remainder bursts. In some examples, each PSS burst of the first plurality of PSS bursts may indicate a respective offset value that indicates a later-occurring PSS burst of the first plurality of PSS bursts that is associated with a next-occurring SSB of the first plurality of SSB remainder bursts. In some examples, the respective offset value may indicate a first value for a first cell and a second value for a second cell. In some examples, the first SSB remainder burst periodicity may indicate a first periodicity associated with the first cell and a second periodicity associated with the second cell. In some examples, each PSS burst of the first plurality of PSS bursts is associated with one or more first beams over which the PSS burst is transmitted. In some examples, each SSB remainder burst of the first plurality of SSB remainder bursts is associated with one or more second beams over which the SSB remainder burst is transmitted and the one or more second beams are narrower than the one or more first beams, and wherein a quantity of the one or more second beams is greater than a quantity of the one or more first beams.

At 1024, the network entity 105-b may transmit, based on a first change of the connection status and in accordance with a second transmission pattern, a second plurality of SSB remainder bursts, the second transmission pattern indicating a second SSB remainder burst periodicity that is smaller than the first SSB remainder burst periodicity. In some examples, transmission of each SSB of each SSB remainder burst of the second plurality of SSB remainder bursts may include outputting of a tracking reference signal, a channel state information reference signal, or both. In some examples, the first change of the connection status may include a change from an idle status to a connected status. In some examples, at least a portion of the first plurality of SSB remainder bursts, the second plurality of SSB remainder bursts, or both may include SSB remainder bursts that include fewer symbols than a remaining portion of the first plurality of SSB remainder bursts, the second plurality of SSB remainder bursts, or both.

At 1026, the network entity 105-b may transmit, based on a second change in the connection status and in accordance with a third transmission pattern, a second plurality of PSS bursts and a third plurality of SSB remainder bursts, the third transmission pattern indicating a second PSS burst length, a second PSS burst periodicity, and a third SSB remainder burst periodicity indicating at least a subset of the second plurality of PSS bursts that are associated with the third plurality of SSB remainder bursts. In some examples, the third SSB remainder burst periodicity is less than the first SSB remainder burst periodicity and is greater than the second SSB remainder burst periodicity. In some examples, the third SSB remainder burst periodicity is equal to the second PSS burst periodicity. In some examples, each respective PSS burst of the second plurality of PSS bursts may include a set of PSS transmissions associated with discontinuous SSB identifiers that are associated with a respective SSB remainder burst of the third plurality of SSB remainder bursts.

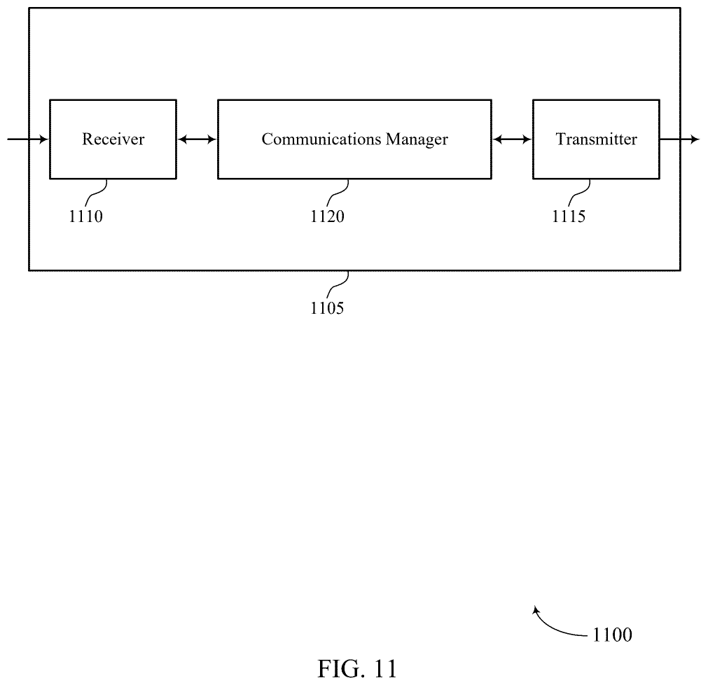

FIG. 11 shows a block diagram 1100 of a device 1105 that supports SSB pattern switching in accordance with one or more examples as disclosed herein. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of SSB pattern switching as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

Additionally, or alternatively, the communications manager 1120 may support wireless communications in accordance with examples as disclosed herein. For example, the communications manager 1120 is capable of, configured to, or operable to support a means for transmitting, based on a connection status of one or more wireless devices that are associated with the network entity and in accordance with a first transmission pattern, a first set of multiple PSS bursts and a first set of multiple synchronization signal blocks (SSB) remainder bursts, the first transmission pattern indicating a first PSS burst length, a first PSS burst periodicity, and a first SSB remainder burst periodicity indicating at least a subset of the first set of multiple PSS bursts that are associated with the first set of multiple SSB remainder bursts. The communications manager 1120 is capable of, configured to, or operable to support a means for transmitting, based on a first change of the connection status and in accordance with a second transmission pattern, a second set of multiple SSB remainder bursts, the second transmission pattern indicating a second SSB remainder burst periodicity that is smaller than the first SSB remainder burst periodicity.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, more efficient utilization of communication resources, or any combination thereof.

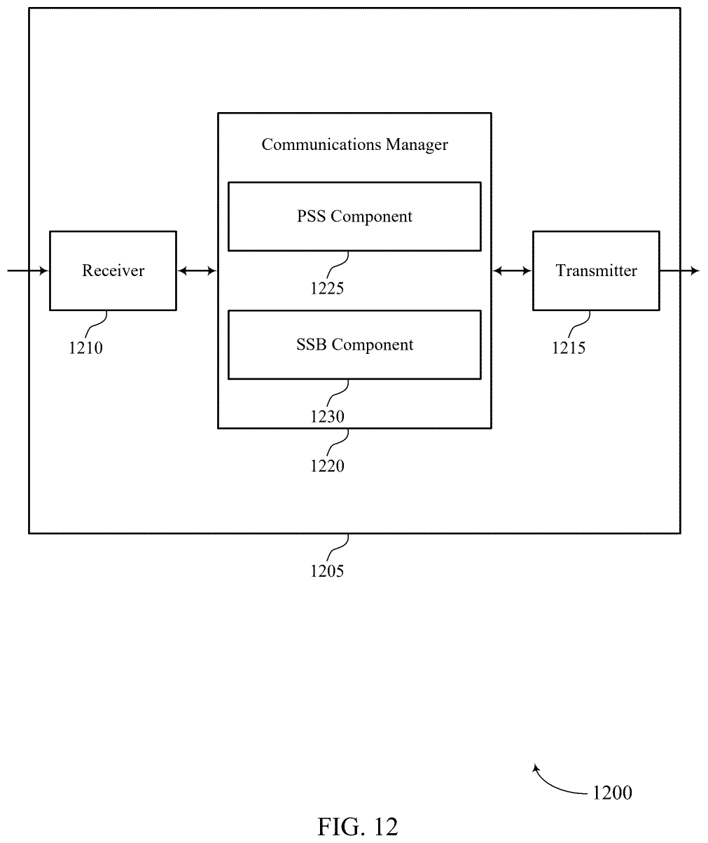

FIG. 12 shows a block diagram 1200 of a device 1205 that supports SSB pattern switching in accordance with one or more examples as disclosed herein. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of SSB pattern switching as described herein. For example, the communications manager 1220 may include an PSS component 1225 an SSB component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The PSS component 1225 is capable of, configured to, or operable to support a means for transmitting, based on a connection status of one or more wireless devices that are associated with the network entity and in accordance with a first transmission pattern, a first set of multiple PSS bursts and a first set of multiple synchronization signal blocks (SSB) remainder bursts, the first transmission pattern indicating a first PSS burst length, a first PSS burst periodicity, and a first SSB remainder burst periodicity indicating at least a subset of the first set of multiple PSS bursts that are associated with the first set of multiple SSB remainder bursts. The SSB component 1230 is capable of, configured to, or operable to support a means for transmitting, based on a first change of the connection status and in accordance with a second transmission pattern, a second set of multiple SSB remainder bursts, the second transmission pattern indicating a second SSB remainder burst periodicity that is smaller than the first SSB remainder burst periodicity.

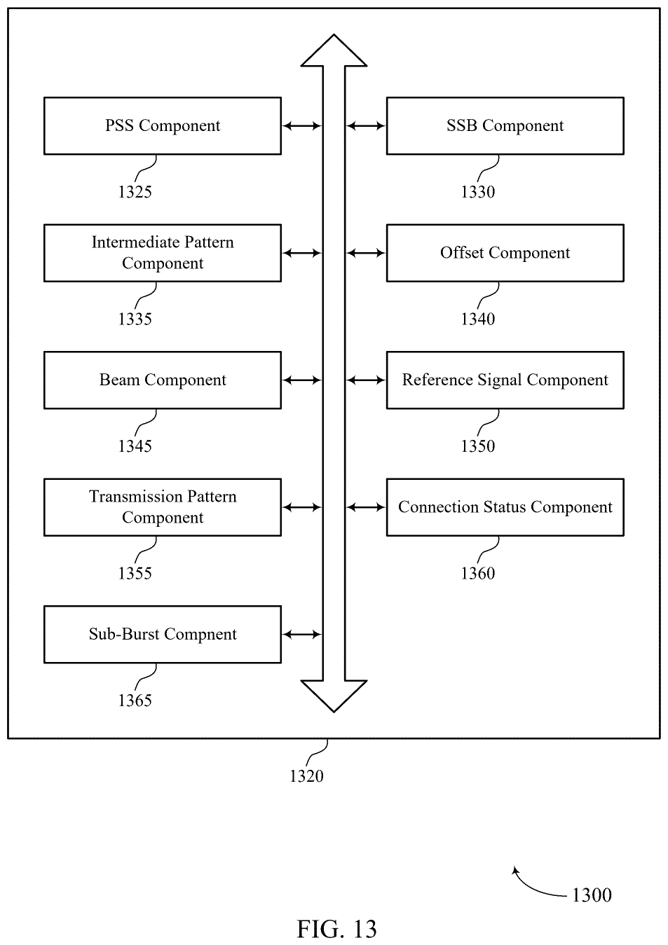

FIG. 13 shows a block diagram 1300 of a communications manager 1320 that supports SSB pattern switching in accordance with one or more examples as disclosed herein. The communications manager 1320 may be an example of aspects of a communications manager 1120, a communications manager 1220, or both, as described herein. The communications manager 1320, or various components thereof, may be an example of means for performing various aspects of SSB pattern switching as described herein. For example, the communications manager 1320 may include an PSS component 1325, an SSB component 1330, an intermediate pattern component 1335, an offset component 1340, a beam component 1345, a reference signal component 1350, a transmission pattern component 1355, a connection status component 1360, a sub-burst component 1365, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Additionally, or alternatively, the communications manager 1320 may support wireless communications in accordance with examples as disclosed herein. The PSS component 1325 is capable of, configured to, or operable to support a means for transmitting, based on a connection status of one or more wireless devices that are associated with the network entity and in accordance with a first transmission pattern, a first set of multiple PSS bursts and a first set of multiple synchronization signal blocks (SSB) remainder bursts, the first transmission pattern indicating a first PSS burst length, a first PSS burst periodicity, and a first SSB remainder burst periodicity indicating at least a subset of the first set of multiple PSS bursts that are associated with the first set of multiple SSB remainder bursts. The SSB component 1330 is capable of, configured to, or operable to support a means for transmitting, based on a first change of the connection status and in accordance with a second transmission pattern, a second set of multiple SSB remainder bursts, the second transmission pattern indicating a second SSB remainder burst periodicity that is smaller than the first SSB remainder burst periodicity.

In some examples, the intermediate pattern component 1335 is capable of, configured to, or operable to support a means for transmitting, based on a second change in the connection status and in accordance with a third transmission pattern, a second set of multiple PSS bursts and a third set of multiple SSB remainder bursts, the third transmission pattern indicating a second PSS burst length, a second PSS burst periodicity, and a third SSB remainder burst periodicity indicating at least a subset of the second set of multiple PSS bursts that are associated with the third set of multiple SSB remainder bursts.

In some examples, the third SSB remainder burst periodicity is less than the first SSB remainder burst periodicity and is greater than the second SSB remainder burst periodicity.

In some examples, the third SSB remainder burst periodicity is equal to the second PSS burst periodicity.

In some examples, each respective PSS burst of the second set of multiple PSS bursts includes a set of PSS transmissions associated with discontinuous SSB identifiers that are associated with a respective SSB remainder burst of the third set of multiple SSB remainder bursts.

In some examples, each PSS burst indicates of the first set of multiple PSS bursts indicates a respective offset value that indicates a later-occurring PSS burst of the first set of multiple PSS bursts that is associated with a next-occurring SSB of the first set of multiple SSB remainder bursts.

In some examples, the respective offset value indicates a first value for a first cell and a second value for a second cell. In some examples, the first SSB remainder burst periodicity indicates a first periodicity associated with the first cell and a second periodicity associated with the second cell.

In some examples, each PSS burst of the first set of multiple PSS bursts is associated with one or more first beams over which the PSS burst is transmitted. In some examples, each SSB remainder burst of the first set of multiple SSB remainder bursts is associated with one or more second beams over which the SSB remainder burst is transmitted, where the one or more second beams are narrower than the one or more first beams, and where a quantity of the one or more second beams is greater than a quantity of the one or more first beams.

In some examples, transmission of each SSB of each SSB remainder burst of the second set of multiple SSB remainder bursts includes outputting of a tracking reference signal, a channel state information reference signal, or both.

In some examples, the transmission pattern component 1355 is capable of, configured to, or operable to support a means for transmitting an indication of the first transmission pattern, the second transmission pattern, or both, where the indication is associated with operation of a secondary cell.

In some examples, the indication of the first transmission pattern, the second transmission pattern, or both, includes an indication of one or more pattern indices.

In some examples, the first change of the connection status includes a change from an idle status to a connected status.

In some examples, at least a portion of the first set of multiple SSB remainder bursts, the second set of multiple SSB remainder bursts, or both includes SSB remainder bursts that include fewer symbols than a remaining portion of the first set of multiple SSB remainder bursts, the second set of multiple SSB remainder bursts, or both.

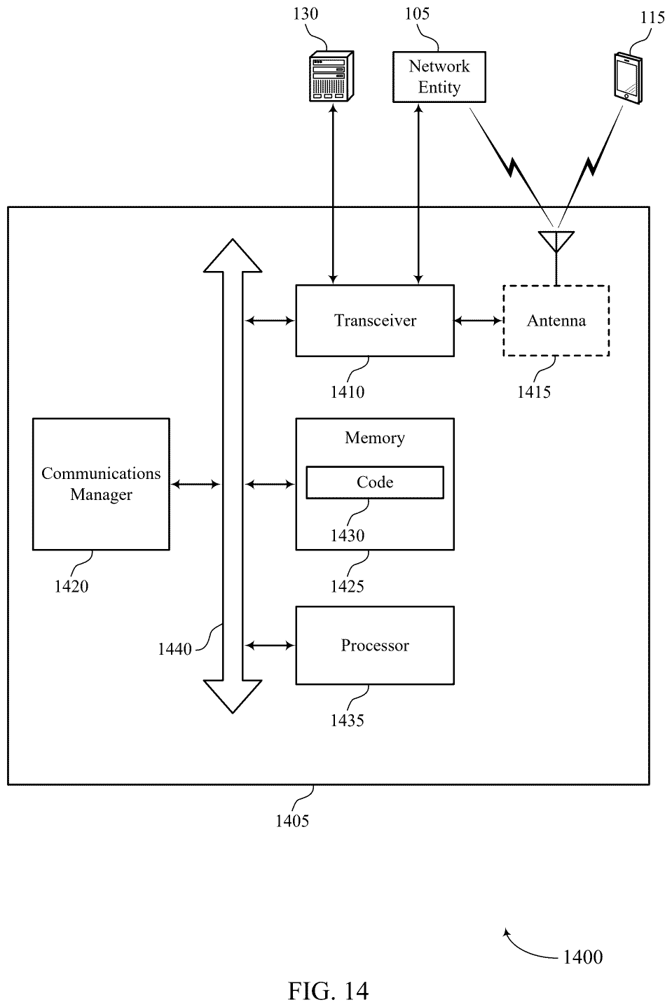

FIG. 14 shows a diagram of a system 1400 including a device 1405 that supports SSB pattern switching in accordance with one or more examples as disclosed herein. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting SSB pattern switching). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

Additionally, or alternatively, the communications manager 1420 may support wireless communications in accordance with examples as disclosed herein. For example, the communications manager 1420 is capable of, configured to, or operable to support a means for transmitting, based on a connection status of one or more wireless devices that are associated with the network entity and in accordance with a first transmission pattern, a first set of multiple PSS bursts and a first set of multiple synchronization signal blocks (SSB) remainder bursts, the first transmission pattern indicating a first PSS burst length, a first PSS burst periodicity, and a first SSB remainder burst periodicity indicating at least a subset of the first set of multiple PSS bursts that are associated with the first set of multiple SSB remainder bursts. The communications manager 1420 is capable of, configured to, or operable to support a means for transmitting, based on a first change of the connection status and in accordance with a second transmission pattern, a second set of multiple SSB remainder bursts, the second transmission pattern indicating a second SSB remainder burst periodicity that is smaller than the first SSB remainder burst periodicity.

By including or configuring the communications manager 1420 in accordance with examples as described herein, the device 1405 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of SSB pattern switching as described herein, or the at least one processor 1435 and the at least one memory 1425 may be otherwise configured to, individually or collectively, perform or support such operations.

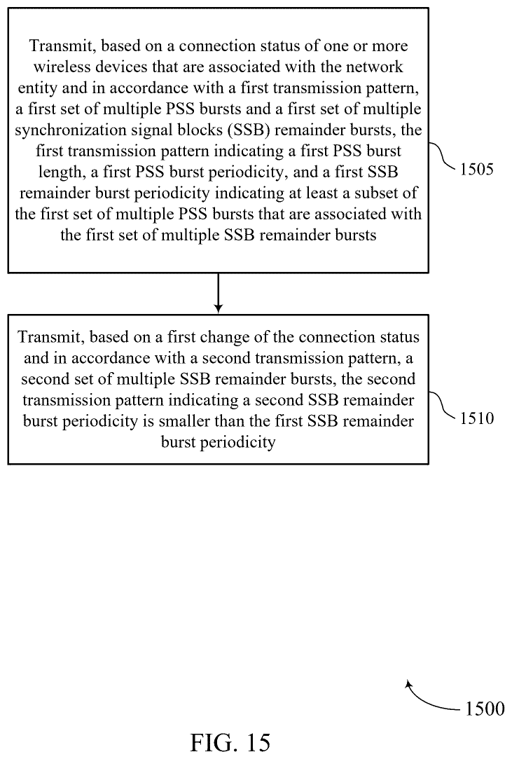

FIG. 15 shows a flowchart illustrating a method 1500 that supports SSB pattern switching in accordance with one or more examples as disclosed herein. The operations of the method 1500 may be implemented by a network entity or its components as described herein. For example, the operations of the method 1500 may be performed by a network entity as described with reference to FIGS. 1 through 14. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, based on a connection status of one or more wireless devices that are associated with the network entity and in accordance with a first transmission pattern, a first set of multiple PSS bursts and a first set of multiple synchronization signal blocks (SSB) remainder bursts, the first transmission pattern indicating a first PSS burst length, a first PSS burst periodicity, and a first SSB remainder burst periodicity indicating at least a subset of the first set of multiple PSS bursts that are associated with the first set of multiple SSB remainder bursts. The operations of 1505 may be performed in accordance with examples as disclosed herein. In some examples, aspects of the operations of 1505 may be performed by an PSS component 1325 as described with reference to FIG. 13.

At 1510, the method may include transmitting, based on a first change of the connection status and in accordance with a second transmission pattern, a second set of multiple SSB remainder bursts, the second transmission pattern indicating a second SSB remainder burst periodicity that is smaller than the first SSB remainder burst periodicity. The operations of 1510 may be performed in accordance with examples as disclosed herein. In some examples, aspects of the operations of 1510 may be performed by an SSB component 1330 as described with reference to FIG. 13.

The following provides an overview of aspects of the present disclosure:

Aspect 1: A method for wireless communications at a network entity, comprising: transmitting, based at least in part on a connection status of one or more wireless devices that are associated with the network entity and in accordance with a first transmission pattern, a first plurality of PSS bursts and a first plurality of synchronization signal blocks (SSB) remainder bursts, the first transmission pattern indicating a first PSS burst length, a first PSS burst periodicity, and a first SSB remainder burst periodicity indicating at least a subset of the first plurality of PSS bursts that are associated with the first plurality of SSB remainder bursts; and transmitting, based at least in part on a first change of the connection status and in accordance with a second transmission pattern, a second plurality of SSB remainder bursts, the second transmission pattern indicating a second SSB remainder burst periodicity is smaller than the first SSB remainder burst periodicity.

Aspect 2: The method of aspect 1, further comprising: transmitting, based at least in part on a second change in the connection status and in accordance with a third transmission pattern, a second plurality of PSS bursts and a third plurality of SSB remainder bursts, the third transmission pattern indicating a second PSS burst length, a second PSS burst periodicity, and a third SSB remainder burst periodicity indicating at least a subset of the second plurality of PSS bursts that are associated with the third plurality of SSB remainder bursts.

Aspect 3: The method of aspect 2, wherein the third SSB remainder burst periodicity is less than the first SSB remainder burst periodicity and is greater than the second SSB remainder burst periodicity.

Aspect 4: The method of any of aspects 2 through 3, wherein the third SSB remainder burst periodicity is equal to the second PSS burst periodicity.

Aspect 5: The method of aspect 4, wherein each respective PSS burst of the second plurality of PSS bursts comprises a set of PSS transmissions associated with discontinuous SSB identifiers that are associated with a respective SSB remainder burst of the third plurality of SSB remainder bursts.

Aspect 6: The method of any of aspects 1 through 5, wherein each PSS burst indicates of the first plurality of PSS bursts indicates a respective offset value that indicates a later-occurring PSS burst of the first plurality of PSS bursts that is associated with a next-occurring SSB of the first plurality of SSB remainder bursts.

Aspect 7: The method of aspect 6, wherein the respective offset value indicates a first value for a first cell and a second value for a second cell; and the first SSB remainder burst periodicity indicates a first periodicity associated with the first cell and a second periodicity associated with the second cell.

Aspect 8: The method of any of aspects 1 through 7, wherein each PSS burst of the first plurality of PSS bursts is associated with one or more first beams over which the PSS burst is transmitted; and each SSB remainder burst of the first plurality of SSB remainder bursts is associated with one or more second beams over which the SSB remainder burst is transmitted, wherein the one or more second beams are narrower than the one or more first beams, and wherein a quantity of the one or more second beams is greater than a quantity of the one or more first beams.

Aspect 9: The method of any of aspects 1 through 8, wherein transmission of each SSB of each SSB remainder burst of the second plurality of SSB remainder bursts comprises outputting of a tracking reference signal, a channel state information reference signal, or both.

Aspect 10: The method of any of aspects 1 through 9, further comprising: transmitting an indication of the first transmission pattern, the second transmission pattern, or both, wherein the indication is associated with operation of a secondary cell.

Aspect 11: The method of aspect 10, wherein the indication of the first transmission pattern, the second transmission pattern, or both, comprises an indication of one or more pattern indices.

Aspect 12: The method of any of aspects 1 through 11, wherein the first change of the connection status comprises a change from an idle status to a connected status.

Aspect 13: The method of any of aspects 1 through 12, wherein at least a portion of the first plurality of SSB remainder bursts, the second plurality of SSB remainder bursts, or both comprises SSB remainder bursts that include fewer symbols than a remaining portion of the first plurality of SSB remainder bursts, the second plurality of SSB remainder bursts, or both.

Aspect 14: A network entity for wireless communications, comprising one or more memories storing processor-executable code, and one or more processors coupled with the one or more memories and individually or collectively operable to execute the code to cause the network entity to perform a method of any of aspects 1 through 13.

Aspect 15: A network entity for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
transmit, based at least in part on a connection status of one or more wireless devices that are associated with the network entity and in accordance with a first transmission pattern, a first plurality of primary synchronization signal (PSS) bursts and a first plurality of synchronization signal blocks (SSB) remainder bursts, the first transmission pattern indicating a first PSS burst length, a first PSS burst periodicity, and a first SSB remainder burst periodicity indicating at least a subset of the first plurality of PSS bursts that are associated with the first plurality of SSB remainder bursts; and
transmit, based at least in part on a first change of the connection status and in accordance with a second transmission pattern, a second plurality of SSB remainder bursts, the second transmission pattern indicating a second SSB remainder burst periodicity that is smaller than the first SSB remainder burst periodicity.

2. The network entity of claim 1, wherein the one or more processors are individually or collectively further operable to execute the code to cause the network entity to:
transmit, based at least in part on a second change in the connection status and in accordance with a third transmission pattern, a second plurality of PSS bursts and a third plurality of SSB remainder bursts, the third transmission pattern indicating a second PSS burst length, a second PSS burst periodicity, and a third SSB remainder burst periodicity indicating at least a subset of the second plurality of PSS bursts that are associated with the third plurality of SSB remainder bursts.

3. The network entity of claim 2, wherein the third SSB remainder burst periodicity is less than the first SSB remainder burst periodicity and is greater than the second SSB remainder burst periodicity.

4. The network entity of claim 2, wherein the third SSB remainder burst periodicity is equal to the second PSS burst periodicity.

5. The network entity of claim 4, wherein each respective PSS burst of the second plurality of PSS bursts comprises a set of PSS transmissions associated with discontinuous SSB identifiers that are associated with a respective SSB remainder burst of the third plurality of SSB remainder bursts.

6. The network entity of claim 1, wherein each PSS burst indicates of the first plurality of PSS bursts indicates a respective offset value that indicates a later-occurring PSS burst of the first plurality of PSS bursts that is associated with a next-occurring SSB of the first plurality of SSB remainder bursts.

7. The network entity of claim 6, wherein:
the respective offset value indicates a first value for a first cell and a second value for a second cell; and
the first SSB remainder burst periodicity indicates a first periodicity associated with the first cell and a second periodicity associated with the second cell.

8. The network entity of claim 1, wherein:
each PSS burst of the first plurality of PSS bursts is associated with one or more first beams over which the PSS burst is transmitted; and
each SSB remainder burst of the first plurality of SSB remainder bursts is associated with one or more second beams over which the SSB remainder burst is transmitted, wherein the one or more second beams are narrower than the one or more first beams, and wherein a quantity of the one or more second beams is greater than a quantity of the one or more first beams.

9. The network entity of claim 1, wherein transmission of each SSB of each SSB remainder burst of the second plurality of SSB remainder bursts comprises outputting of a tracking reference signal, a channel state information reference signal, or both.

10. The network entity of claim 1, wherein the one or more processors are individually or collectively further operable to execute the code to cause the network entity to:
transmit an indication of the first transmission pattern, the second transmission pattern, or both, wherein the indication is associated with operation of a secondary cell.

11. The network entity of claim 10, wherein the indication of the first transmission pattern, the second transmission pattern, or both, comprises an indication of one or more pattern indices.

12. The network entity of claim 1, wherein the first change of the connection status comprises a change from an idle status to a connected status.

13. The network entity of claim 1, wherein at least a portion of the first plurality of SSB remainder bursts, the second plurality of SSB remainder bursts, or both comprises SSB remainder bursts that include fewer symbols than a remaining portion of the first plurality of SSB remainder bursts, the second plurality of SSB remainder bursts, or both.

14. A method for wireless communications at a network entity, comprising:
transmitting, based at least in part on a connection status of one or more wireless devices that are associated with the network entity and in accordance with a first transmission pattern, a first plurality of primary synchronization signal (PSS) bursts and a first plurality of synchronization signal blocks (SSB) remainder bursts, the first transmission pattern indicating a first PSS burst length, a first PSS burst periodicity, and a first SSB remainder burst periodicity indicating at least a subset of the first plurality of PSS bursts that are associated with the first plurality of SSB remainder bursts; and
transmitting, based at least in part on a first change of the connection status and in accordance with a second transmission pattern, a second plurality of SSB remainder bursts, the second transmission pattern indicating a second SSB remainder burst periodicity that is smaller than the first SSB remainder burst periodicity.

15. The method of claim 14, further comprising:
transmitting, based at least in part on a second change in the connection status and in accordance with a third transmission pattern, a second plurality of PSS bursts and a third plurality of SSB remainder bursts, the third transmission pattern indicating a second PSS burst length, a second PSS burst periodicity, and a third SSB remainder burst periodicity indicating at least a subset of the second plurality of PSS bursts that are associated with the third plurality of SSB remainder bursts.

16. The method of claim 15, wherein the third SSB remainder burst periodicity is less than the first SSB remainder burst periodicity and is greater than the second SSB remainder burst periodicity.

17. The method of claim 15, wherein the third SSB remainder burst periodicity is equal to the second PSS burst periodicity.

18. The method of claim 17, wherein each respective PSS burst of the second plurality of PSS bursts comprises a set of PSS transmissions associated with discontinuous SSB identifiers that are associated with a respective SSB remainder burst of the third plurality of SSB remainder bursts.

19. The method of claim 14, wherein each PSS burst indicates of the first plurality of PSS bursts indicates a respective offset value that indicates a later-occurring PSS burst of the first plurality of PSS bursts that is associated with a next-occurring SSB of the first plurality of SSB remainder bursts.

20. A network entity for wireless communications, comprising:
means for transmitting, based at least in part on a connection status of one or more wireless devices that are associated with the network entity and in accordance with a first transmission pattern, a first plurality of primary synchronization signal (PSS) bursts and a first plurality of synchronization signal blocks (SSB) remainder bursts, the first transmission pattern indicating a first PSS burst length, a first PSS burst periodicity, and a first SSB remainder burst periodicity indicating at least a subset of the first plurality of PSS bursts that are associated with the first plurality of SSB remainder bursts; and
means for transmitting, based at least in part on a first change of the connection status and in accordance with a second transmission pattern, a second plurality of SSB remainder bursts, the second transmission pattern indicating a second SSB remainder burst periodicity that is smaller than the first SSB remainder burst periodicity.
